(19) United States
(12) Patent Application Publication
(10) Pub. No.: US 2023/0222674 A1
(43) Pub. Date: Jul. 13, 2023

(54) PORTABLE ITEM TRACKING

(71) Applicant: Sling Media Pvt Ltd., Englewood, CO (US)

(72) Inventors: Vikram Balarajashetty, Kundalahalli (IN); Arun Pulasseri Kalam, Varthur (IN); Pragna G Shastry, Andrahalli (IN); Ananda Siddappa, KR Puram (IN)

(73) Assignee: Sling Media Pvt Ltd., Englewood, CO (US)

(21) Appl. No.: 17/575,497

(22) Filed: Jan. 13, 2022

(51) Int. Cl. G06T 7/246; G06V 20/00; G06T 7/73; G06T 7/292; H04W 4/029

(52) U.S. Cl. CPC G06T 7/251; G06T 7/75; G06T 7/292; G06V 20/00; H04W 4/029

(57) ABSTRACT

A system, tracking an object within an environ, includes a hub with a processor instantiating a vision recognizer, a data store storing location data including a first location model, and a first camera which captures and provides, within a first field of view (FOV), a first image to the hub. The first image includes a first depiction of a first captured location, and the vision recognizer determines an object is present at the first location when the first depiction of the first captured location corresponds to the first location model. The first image depicts an element present within the first FOV, the data store further stores an image library record including a first object model, and the vision recognizer determines whether the object is present at the first location when the element depicted in the first image corresponds to the object as modeled by the first object model.

### TECHNICAL FIELD

The technology described herein generally relates to devices, systems, and processes for tracking and identifying a current location for items, such as remote controls, keys, books, medicines, and the like.

### BACKGROUND

Devices, systems, and processes are needed for tracking movement of and identifying current locations of one or more portable items by a user. As is well appreciated, a person will often move about their house, office or other environment and pick-up and place down assorted items, such as car keys. The placement, by a person, of such portable items often occurs randomly and without knowledge or forethought by the person so placing the portable item and/or others who may later need to access and/or utilize the portable item. Accordingly, the present location of the portable item may be unknown and given the size, characteristics or other elements of the portable item, identifying and using the portable item may be time consuming and occasionally even non-achievable.

Accordingly, needs exist for systems, devices and methods for identifying and tracking one or more portable items within a given environment such that a later access to and/or utilization of such portable item can occur without incurring undue delays of greater than an amount of time to access a database identifying a then known current location of the portable item, proceeding to the known current location and retrieving the portable item for a given use or otherwise.

### SUMMARY

The various implementations of the present disclosure relate in general to devices, systems, and processes for tracking portable items within a given environment.

In accordance with at least one implementation of the present disclosure, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect for a system includes hub. The hub may include a processor executing non-transient computer instructions which instantiate a vision recognizer. The hub may also include a data store, coupled to the processor, non-transiently storing a location data record including a first location model for a first location. The system may include a first camera, coupled to the hub. The first camera may be positioned to capture, within a first field of view (FOV), a first image and provide the first image to the hub. The first FOV may cover a first captured location. The first image may include a first depiction of the first captured location. The vision recognizer may determine whether an object is present at the first location by determining whether the first depiction of the first captured location in the first image corresponds to the first location model for the first location. Other embodiments of this aspect include corresponding computer systems, apparatus, and computer programs recorded on one or more computer storage devices, each configured to perform the actions of the methods.

Implementations may include one or more of the following features. The first image may depict an element, if any, present within the first FOV. The data store may store an image library record that includes a first object model for the object. The vision recognizer may determine whether the object is present at the first location by determining whether the element depicted in the first image corresponds to the object as modeled by the first object model. The object may be a portable item.

The vision recognizer may detect whether the object is present at the first location by further executing instructions which may include first orienting the first location model to a first reference coordinate system; and second orienting the first object model to the first reference coordinate system.

The vision recognizer may detect whether the object is present at the first location by further executing instructions for: third orienting the first image to the first reference coordinate system; and where the determining of whether an object is present at the first location uses the first object model as second oriented to the first reference coordinate system.

The vision recognizer may detect whether the object is present at the first location by further executing instructions which may include: obtaining a second object model; third orienting the second object model to the first reference coordinate system; and where the determining of whether the element depicted in the first image corresponds to the object as modeled by the first object model further may include: searching, utilizing the second object model, as third oriented, for the object in the first image.

The vision recognizer may detect whether the object is present at the first location by further executing instructions which may include: iteratively obtaining a third object model through an nth object model of the object; where n is an integer; orienting the third object model through the nth object model to the first reference coordinate system; and searching, until detected, for the object in the first image using the third object model through nth object model. Upon detection of the object in the first image for an iterative given utilization of one of the third object model through the nth object model, the instructions further may include: identifying the object as being present at the location; and where, upon non-detection of the object in the first image after the nth object model, the instructions further may include: determining the object is not present at the first location.

The vision recognizer may detect whether the object is present at the first location by further executing instructions which may include: obtaining a second location model; orienting the second location model to the first reference coordinate system; and iteratively: obtaining the second object model through the nth object model; orienting the second object model through nth object model to the first reference coordinate system; and searching for the object in the first image.

At least one of the first location model and the second location model may include a three-dimensional (3d) location model. At least one of the first object model through the nth object model may include a 3d object model. The vision recognizer may detect whether the object is present at the first location by further executing instructions which may include: iteratively rotating, around an axis of the first reference coordinate system: the 3d location model; the 3d object model; and the image; and searching for the object in the first image with an iterative rotation of the first reference coordinate system.

The system may include a second camera positioned to capture, within a second FOV, a second image of the first location and provide the second image to the hub. The vision recognizer may determine, based upon the second image, the image library record and the location data record whether the object is present at the first location at the second image capture time. The first image capture time and the second image capture time may occur simultaneously.

The system may include a portable item location tracking system (PILTS) that includes a portable item location tag (PILT), attached to the object, and a portable item location node (PILN), attached to the first camera. The PILT may be coupled to the PILN when the PILT is located within a wireless communications signal range of a lesser of the PILT and the PILN. The PILTS may provide, to the hub, object location information for the object when the PILT is coupled to the PILN. The object location information may be stored in a portable item location (PIL) data record. The vision recognizer may detect whether the object is present at the first location by further executing instructions which may include: obtaining the object location information from the PIL data record; and determining, based on the object location information, whether to take any further actions to determine whether the object is present at the first location.

The data store further may include: a user location data record storing the user tracking data (UTD); and where, during a normal day, the UTD is concomitant with a user of the object. When the object is not present at the first location, the instructions further may include: identifying where the user has traveled throughout the environ, as indicated by the stored UTD; identifying, based on the UTD, a second location within a second FOV of a second camera; where the second camera provides second images of the second location to the hub for storage in an image library record maintained by the data store; retrieving, from the data store, at least one of second image corresponding to when the user was at the second location, as identified by the UTD; and determining whether the object is present at the second location.

The location data record may include a second location model for the second location. The operation of determining of whether the object is present at the second location may utilize the second location model in place of the first location model. Implementations of the described techniques may include hardware, a method or process, or computer software on a computer-accessible medium.

One general aspect includes a device that may include a processor executing non-transient computer instructions which instantiate a vision recognizer; and a data store, coupled to the processor, non-transiently storing: a location data record including a first location model for a first location; an image library record including a first portable item model for a portable item; a portable item location (PIL) data record storing location data for a portable item; and a user location data record storing user tracking data.

The device may include a vision recognizer which determines whether the portable item is present at a first location by determining whether a first depiction of a first captured location in a first image provided to a hub by a first camera corresponds to a first location model for the first location obtained from the location data record; and whether the portable item is present at the first location by determining whether an element depicted in the first image corresponds to the portable item as modeled by a first portable item model obtained from the image library record. Other embodiments of this aspect include corresponding computer systems, apparatus, and computer programs recorded on one or more computer storage devices, each configured to perform the actions of the methods.

Implementations may include one or more of the following features. The device may include a data store that further non-transiently stores: a portable item location (PIL) data record which identifies at least one of a current or past known location for the portable item; and a user location data record storing user tracking data.

The processor may further execute non-transient computer instructions which instantiate: a user tracker; and a PIL tracker. The vision recognizer may choose, based on the user tracking data and the PIL data, a second camera image to utilize, at a given time, to determine whether the portable item is present at a given location. The second camera image may be captured by a second camera that corresponds to at least one of the current or past known location for the portable item. The vision recognizer may select, based on the user tracking data, a third camera image to use when the portable item is not detected using the first image or the second image. The third camera image may correspond to a current or past known location of the user, as identified in the user tracking data. Implementations of the described techniques may include hardware, a method or process, or computer software on a computer-accessible medium.

One general aspect includes a computer readable medium non-transiently storing computer instructions which, when executed by a processor, instruct a hub to perform operations including: first determining whether a portable item is present at a first location by determining whether a first depiction of a first captured location in a first image captured by a first camera in a system tracking portable items corresponds to a first location model, for the first location, obtained from a location data record stored by a hub device. The operations may further include second determining whether the portable item is present at the first location by determining whether an element depicted in the first image corresponds to the portable item as modeled by a first object model obtained from an image library record stored by the hub device. Other embodiments of this aspect include corresponding computer systems, apparatus, and computer programs recorded on one or more computer storage devices, each configured to perform the actions of the methods.

### BRIEF DESCRIPTION OF THE DRAWINGS

The features, aspects, advantages, functions, modules, and components of the devices, systems and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a – 108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference number irrespective of any additional alphabetic designators or second reference labels, if any.

FIG. 1A is an illustrative diagram of an implementation, in a house, of a system for item tracking that includes one or more cameras and in accordance with at least one implementation of the present disclosure.

FIG. 1B is an illustrative diagram of an implementation, in a house, of a system for item tracking that includes one or more cameras and a portable item location tracking system and in accordance with at least one implementation of the present disclosure.

FIG. 1C is an illustrative diagram of an implementation, in a house, of a system for item tracking that includes one or more cameras, a portable item location tracking system and a user tracking system and in accordance with at least one implementation of the present disclosure.

FIG. 2 is a schematic diagram of hub for use in the system of FIGS. 1A-1C for item tracking that includes one or more cameras and a portable item location tracking system and in accordance with at least one implementation of the present disclosure.

FIG. 3 is a flow chart illustrating a process for tracking portable items in accordance with at least one implementation of the present disclosure.

### DETAILED DESCRIPTION

The various implementations described herein are directed to devices, systems, and processes for keeping track of items within a given location, such as a home, office, or otherwise.

As used herein, a “portable item” is any article of commerce that is portable by a person, without mechanical assistance, with non-limiting examples including car keys, house keys, remote control devices, reading glasses, prescription containers, books, key fobs, wallets, ear buds, tablet computing devices, phones (cellular, wireless, mobile and the like), laptop computers, articles of clothing, jewelry, pens, or the like.

As used herein, “user” refers to a person with respect to whom a given portable item is to be tracked. A user typically makes use of the portable item over a period of time, such as continually while awake, hourly, daily, weekly, monthly, or otherwise.

As used herein, an “environ” is a location and a surrounding area about which a user may place a portable item. An environ may include a structure, portions thereof, and one or more surrounding areas. Non-limiting examples of environs include a home, condominium, apartment, or other dwelling units, with a surrounding area including one or more of a yard, a garage, a patio, a swimming pool, courtyard, hallway, or the like. An environ may or may not include a surrounding area. Public spaces, such as parks, offices, stadiums, and the like may also be an environ when such area includes a system for Item tracking in accordance with an implementation of the present disclosure. Further, herein an “environ portion” or “portion” may include a room or other separately identifiable area or portion of an environ, such as a house.

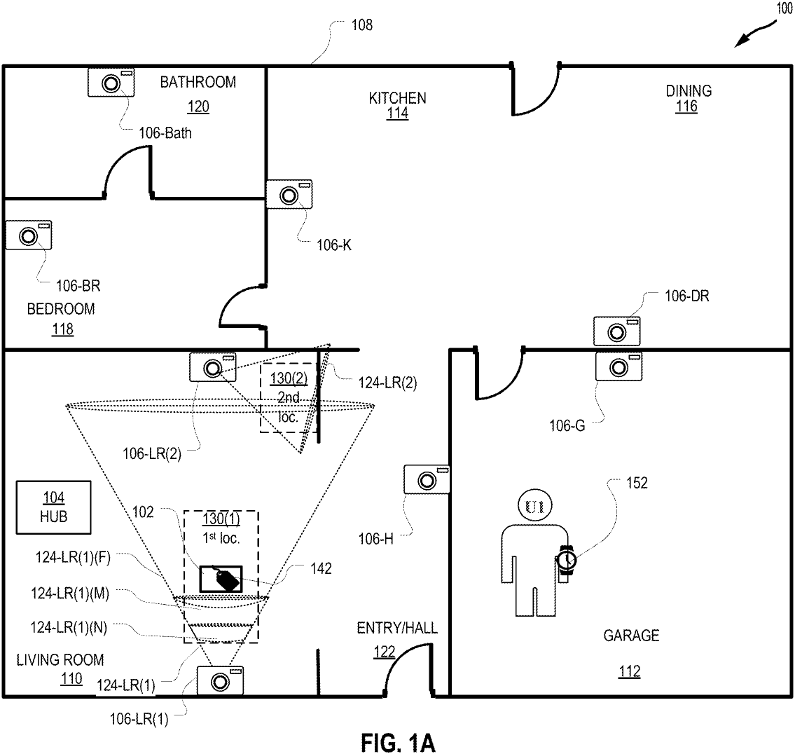

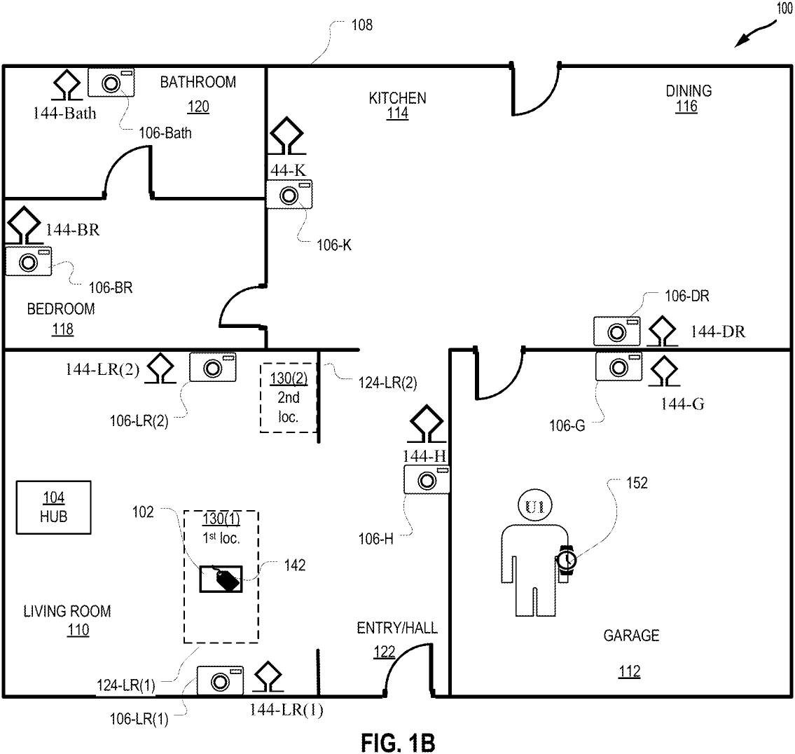

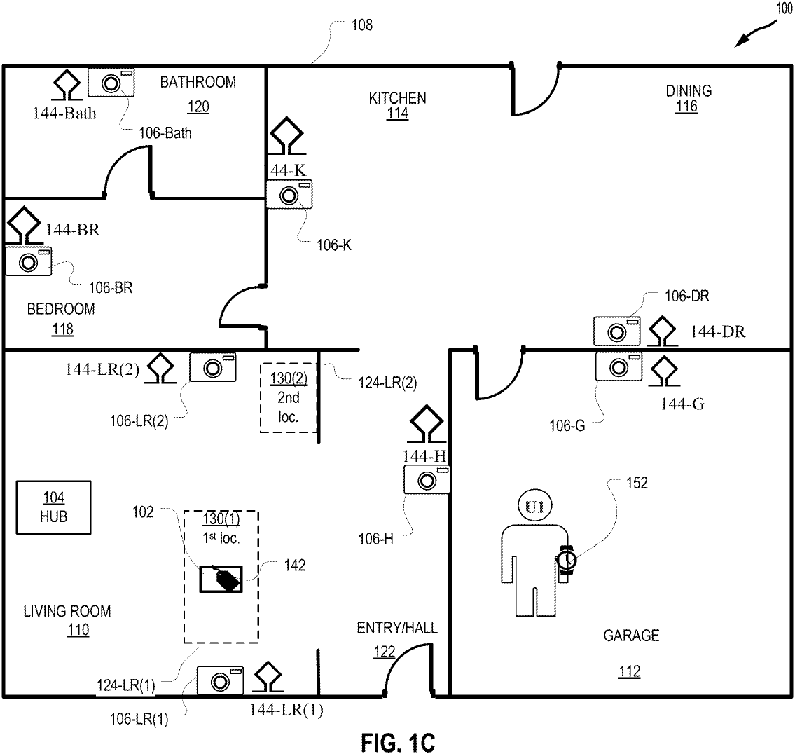

As shown in FIG. 1A and for least one implementation of the present disclosure, a system 100 for tracking one or more portable items 102 may be provided for use within an environ 108, such as a home. The system 100 may include a hub 104 and one or more cameras 106 positioned within and/or proximate to the environ 108.

As shown in FIG. 1B and for at least one implementation, the system 100 may include a portable item location (“PIL”) tracking system (“PILTS”) 140. For at least one implementation, the PILTS 140 may be utilized in an environ portion where cameras are not located. For example, for privacy considerations, cameras may not be located in environ portions 118 and 120. For at least one implementation, pre-stored images of such an environ portion may be stored in the data store 210 for the hub 104 and such pre-stored images with PILT 142 data may be used to identify where a portable item is likely located within the environ portion.

The PILTS 140 may include a portable item location tag (a “PILT”) 142, which may be affixed or otherwise secured to a given portable item 102. The PILTS 140 may include one or more portable item location nodes (a “PILN”) 144 located about an environ. The PILT 142 and PILN 144 are configured to communicate one or more radio frequency (RF) signals therebetween and based on such RF signals, the hub 104 identifies a current location of a given PILT 142 (and, when attached, a given portable item 102), within an environ and at a within a given positional accuracy, as determined in view of the configuration and then occurring operational use of the PILTS 140. The PILT and PILN are wirelessly coupled when positioned within a lesser of wireless communications signal ranges for the PILT and the PILN.

A PILT 142 and a PILN 144 include at least one antenna, a processor, a transceiver and other commonly known and/or later arising portable item tracking components. A PILT 142 and a PILN 144 may be configured to use any known or later arising item tracking protocols, communications technologies, or the like. One non-limiting example is radio frequency identification (RFID) technologies, which are well known in the art. For an implementation, the PILT 142 and PILN 144 may be actively powered, such as by solar energy, by a battery, or otherwise. For an implementation, the PILT 142 and PILN 144 may use one or more of Near Field Communications (NFC), Wi-Fi, BLUETOOH (TM), cellular, near band Internet of Things (NB-IOT), 3G,/4G/5G, or other wireless communications technologies to facilitate position determination and tracking of a portable item 102 with in a given environ or an environ portion, at a location, on a surface or otherwise. A PILT 142 and a PILN 144 may include one or more antennas, transceivers, and the like and are communicatively coupled together. A PILN 144 may be further communicatively coupled, directly or indirectly to (for example by use of a token ring, hybrid network, or otherwise), with the hub 104.

For at least one implementation, A PILN 144 may be provided in conjunction with a camera 106, for example, provided PILNs 144 may include a first living room PILN, a second living room PILN, a hall PILN, a bedroom PILN, a bathroom PILN, a kitchen PILN, a dining room PILN, and a garage PILN. It is to be appreciated that multiple PILNs 144 may be used to couple with and a given PILT 142 and principles of signal triangulation and other known techniques may be used by the hub 104 to determine a location of the PILT 142. For other implementations, a PILT 142 may include built-in positioning technologies, such as global positioning system (GPS) technologies.

As shown in FIG. 1C, for at least one implementation, the system 100 may include a user location tracking system (“ULTS”) 150. The ULTS 150 may be coupled to the PILTS 140 and/or provided separately. The ULTS 150 may include any known or later arising user tracking technologies and user tracker devices (“UTD”) 152. Non-limiting examples of a UTD include smart watches, smart phones, emergency response pendants, fitness trackers, and the like. A UTD 152 may determine and provide user tracking data to the hub 104, which as discussed below, includes a user tracker 206 configured to track a user’s position within an environ. During a “normal day,” which is defined herein to mean day during which the user affixes, wears, attaches, or otherwise carries the UTD with them (herein, as so used, the UTD being “concomitant with the user”), the UTD identifies a user location to a given degree of accuracy, such as on a latitude by longitudinal basis, by an environ, by an environ portion, by a location, or otherwise. The degree of accuracy may vary and for at least one implementation is accurate to within at least an identifiable environ portion, such as a room of a house.

The environ 108 may include one or more delineable environ portions such as a living room 110, a garage 112, a kitchen 114, a dining area 116, a bedroom, 118, a bathroom 120, entry/hall 122, and the like.

A network (not shown) communicatively couples the system 100 elements. The network may utilize any known and/or later arising communications and/or networking technologies, standards, protocols or otherwise. Non-limiting examples of such technologies include packet switch and circuit switched communications technologies, such as and without limitation, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, Internet of Things (IoT) networks, Cloud based networks, private networks, public networks, or otherwise. One or more communications and networking standards and/or protocols may be used including, without limitation, the TCP/IP suite of protocols, the Extensible Message and Presence Protocol (XMPP), VOIP, Ethernet, Wi-Fi, CDMA, GSM/GRPS, TDMA/EDGE, EV/DO, WiMAX, SDR, LTE, MPEG, and others.

“Cloud” refers to cloud computing, cloud storage, cloud communications, and/or other technology resources which a given user does not actively manage or provide. A usage of a Cloud resource may be private (limited to certain users and/or uses), public (available for users and/or uses), hybrid, dedicated, non-dedicated, or otherwise. It is to be appreciated that implementations of the present disclosure may use Cloud resources to provide for processing, storage and other functions.

The environ 108, and environ portions, may include one or more locations 130 at which a given portable item 102 may be located from time to time and/or is otherwise located or not located at any given time. Monitoring of the position of the portable item 102 within the environ 108, including the presence and/or absence of the portable item 102 at a given location 130 and at a given time, may be provided by the system 100.

A location 130 may include one or more surfaces (not shown) upon which a portable item 102 may be placed, dropped, deposited or otherwise located from time to time. Non-limiting examples of surfaces include those provided by cabinets, tables, credenza’s, consoles, chairs, beds, appliances, ledges, stairs, floors, surfaces, or the like (herein, a “surface”). Any number, orientation, types and the like of surfaces may be included at a given location 130. Surfaces present at a given location 130 may vary over time and or portions of a given surface may be viewable by a given camera 106 at a given time, such viewability may vary over time. For purposes of clarity and drawing simplicity, surfaces are not shown in FIGS. 1A-1C.

The system 100 may include one or more cameras 106. The cameras 106 may be coupled to the vision recognizer 204 facilitated by the hub 104. The cameras 106 have a field of view (“FOV”) 124. A camera 106 may be configured to capture still images, videos, hyper lapse images, and/or the like (herein, “images”) of portable items 102, surfaces (e.g., of furniture, floors, or otherwise), users, locations, and other objects (herein, “objects” and, as captured by a camera, “elements” of an image) within the FOV 124 at one or more times and/or over one or more periods.

A given camera 106 may operate at one or more fixed, variable, preset, or otherwise specified resolutions, depths of fields, focal distances, wavelengths (such as visible and infrared), and the like. Herein, such resolutions, depths of fields, focal distances, wavelengths, and the like are individually and collectively referred to as being one or more “camera settings.” A given camera 106 may have one or more FOV124. Such field(s) of view may be fixed or variable, such as by panning, tilting, rotating or other positioning of the camera, digital processing, adjustments of camera settings, or the like.

As shown in FIG. 1A, a first living room camera 106-LR(1) may have a near FOV 106-LR(1)(N), a middle FOV 106-LR(1)(M), and a far FOV 106-LR(1)(F). For a given camera 106, a fixed FOV, a variable/adjustable FOV, or the like may be used. The capability of a given camera 106 to capture an image of an object at a given location 130 may vary based on the position of the portable item 102 relative to the camera 106, the one or more camera settings then being utilized, and the FOV 124 of the camera 106. The elements, locations, and other information depicted by and/or otherwise provided with images captured by a given camera 106, herein are identified as corresponding to a “captured location.”

A camera 106 may be located proximate to a given object, positioned to view one or more of the surfaces of an object, and capture one or more images of the object. Such images may be communicated to the vision recognizer 204 which, as discussed below, is configured to perform image recognition processes and detect when a given portable item 102 is or is not present, on or off a given surface, or the portable item 102 is otherwise disposed, at the given location 130, as captured by a given camera 106.

For example, a first living room camera 106-LR(1), may be positioned to capture object images, at any given time and/or over any given period including continually, of a first surface, such as a top surface of a table (not shown for purposes of drawing simplicity), located within a first location 130(1) and within a first FOV 124-LR(1) for the first living room camera 106-LR(1). Other surfaces, such as a floor area below the table, may not be obscured and out of view of the first living room camera 106-LR(1). Likewise, an animal, user, box, smoke, or other object may obscure the first FOV 124-LR(1). Obscured portions of the top surface may not be viewable using the first living room camera 106-LR(1) from time to time. When obscured, a given camera 106 may not be used to capture images of the top surface and at a given location 130 or of other objects.

As further shown in FIGS. 1, a given enviro portion, such as the living room 110, may include multiple locations at which a given portable item 102 may be positioned from time to time. For example, a television remote control might be positioned at a first time at the first location 130(1), such as on the beforementioned table, while being positioned at a second time at a second location 130(2), such as on a surface of a wall unit, a television console, or the like. For at least one implementation, a given camera 106 may be configured to include multiple locations within a FOV 124 for such camera. For other implementations, multiple cameras may be used to view objects within a given environ portion, such as the living room 110, where a second living room camera 106-LR(2), having a second living room FOV 124-LR(2), may capture images of objects within the second location 130(2). Any number of cameras 106 may be used to capture images of objects within a given environ, such as a house, and within an environ portion, such as a room of a house, or an area external to an environ portions, such as a yard, driveway, or the like proximate to a given environ. For a non-limiting example, a system 100 may include a garage camera 106-G, a hall camera 106-H, a kitchen camera 106-K, a bedroom camera 106-BR, a bathroom camera 106-Bath, a dining room camera 106-DR, and the like.

The system 100 may include a ULTS 150, as shown in FIG. 1C. The user tracker system may be utilized to determine a current location of a given user within the environ. For example, the ULTS 150 whether a user is in bed, at bath, or otherwise. The ULTS 150 may include use of known or future arising user tracking systems, devices and technologies, non-limiting examples including Spot GEN 4(TM) GPS trackers, Apple Computer AIRTAGS(TM), Samsung SMART THINGS TRACKER (TM), and the like.

### Hub 104

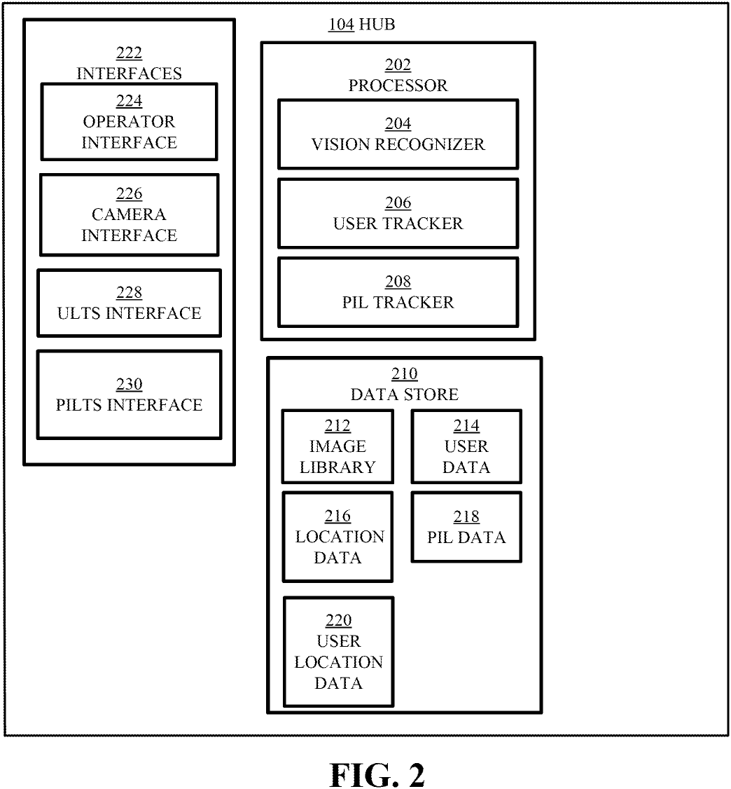

A non-limiting example of the hub 104 is further described below and with respect to FIG. 2. The hub 104 may include one or more of a vision recognizer 204, a user tracker 206, and a portable item location (PIL) tracker 208, which may be provided separately and/or instantiated by a processor 202 in the hub 104 and/or elsewhere and which may be instantiated by one or more processors executing computer instructions which instruct and configure the hub 104 to perform various operations. As shown in FIG. 2, the hub 104 may include a processor 202, a data store 210, and an interface 222. Other common components, such as security components, power supplies, and the like may be provided with the hub 104 and are not shown in FIG. 2. The interface 222 may include an operator interface 224, a camera interface 226, a user tracker interface 228 which facilitates communication of ULTS data with the ULTS 150, and a PILTS interface 230 which facilitates communication of PILT data with PILTS 140.

### Processor 202

A “processor” refers to one or more known or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration, non-limiting examples including local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

An “instruction” (which is also referred to herein as a “computer instruction”) refers to a non-transient processor executable instruction, associated data structure, sequence of operations, program modules, and the like. An instruction is defined by an instruction set. It is commonly appreciated that instruction sets are often processor specific and accordingly an instruction may be executed by a processor in an assembly language or machine language format that is translated from a higher-level programming language. An instruction may be provided using any form of known or later arising programming; non-limiting examples including declarative programming, imperative programming, functional programming, procedural programming, stack-based programming, object-oriented programming, and otherwise.

A “computer engine” (or “engine”) refers to a combination of a “processor” (as described below) and “computer instruction(s)” (as defined below). A computer engine executes computer instructions to perform one or more logical operations (herein, a “logic”) which facilitate various actual (non-logical) and tangible features and function provided by a system, a device, and/or combinations thereof.

“Data” (which is also referred to herein as a “computer data”) refers to any representation of facts, information or concepts in a form suitable for processing by one or more electronic device processors and which, while and/or upon being processed, cause or result in an electronic device or other device to perform at least one function, task, operation, provide a result, or otherwise. Computer data may exist in a transient and/or non-transient form, as determined by any given use of such computer data.

“Module” recites definite structure for an electrical/electronic device that is configured to provide at least one feature and/or output signal and/or perform at least one function including the features, output signals and functions described herein. A module may provide the one or more functions using computer engines, processors, computer instructions and the like. When a feature, output signal and/or function is provided using a processor, one more software components may be used and a given module may be include a processor configured to execute computer instructions. A person of ordinary skill in the art (a “POSITA”) will appreciate that the specific hardware and/or computer instructions used for a given implementation will depend upon the functions to be accomplished by a given module. Likewise, a POSITA will appreciate that such computer instructions may be provided in firmware, as embedded software, provided in a remote and/or local data store, accessed from other sources on an as needed basis, or otherwise. Any known or later arising technologies may be used to provide a given module and the features and functions supported therein.

The processor 202 is configured to instantiate computer applications, logics, engines, and the like facilitating a vision recognizer 204. The processor 202 may be further configured to instantiate computer applications, logics, engines and the like for one or more of a user tracker 206, for use with the ULTS 150, and a PIL tracker 208, for use with the PILTS 140. The processor 202 may be operable to perform data and/or signal processing capabilities with respect to images of objects received from one or more cameras 106 and/or with respect to PILT 142 data and/or UTD 152 data. For at least one implementation, the processor 202 may have access to one or more non-transient processor readable instructions to instantiate the various applications, logics, engines, and the like.

The processor 202 may be configured to execute computer instructions and/or data sets obtained from a data store 210. The data store 210 may be configured using any known or later arising data storage technologies. In at least one implementation, the data store may be configured using flash memory technologies, micro-SD card technology, as a solid-state drive, as a hard drive, as an array of storage devices, or otherwise. The data store may be configured to have any data storage size, read/write speed, redundancy, or otherwise. The data store 210 may be configured to provide temporary/transient and/or permanent/non-transient storage of one or more data sets, computer instructions, and/or other information. Data sets may include, for example, image data regarding one or more portable items 102, as provided in image library records212; user data records 214; location data records 216; portable item location (PIL) data records 218; user location data records 220; and/or other data records. Computer instructions may include firmware and software instructions, and data for use in operating the hub 104. Such data sets may include software instructions configured for execution by the processor 202, another module of the hub 104, or otherwise. Such computer instructions provide computer executable operations that facilitate one or more features or functions of a hub 104 or otherwise. The data store 210 may be further configured to operate in combination and/or conjunction with one or more servers (not shown). The one or more servers may be coupled to the hub 104, a remote storage device (not shown), other devices that are internal and/or external device to the hub 104, to one or more cameras 106, or otherwise. The server(s) may be configured to execute computer instructions which facilitate portable item 102 tracking, identification, presence/absence determinations, and otherwise and in accordance with at least one implementation of the present disclosure. For at least one implementation, one or more of the storage components may be configured to store one more data sets, computer instructions, and/or other information in encrypted form using known or later arising data encryption technologies.

### Vision Recognizer 204

For at least one implementation, a vision recognizer 204 may be instantiated by the hub 104 processor 202 executing computer instructions. The vision recognizer 204 may be configured to execute computer readable instructions which facilitate detection, which is also known as image recognition and/or as computer vision, of a portable item 102 (or another object) at a given location 130, at any time, for a given period, over multiple times and/periods, or otherwise and with respect to one or more locations 130 in an environ 108. Non-limiting examples of image recognition software which may be utilized by the vision recognizer 204 and with an implementation of the present disclosure include AMAZON REKOGNITION (TM), AZURE CUSTOM VISION SERVICE (TM), IBM WATSON VISUAL RECOGNITION (TM), SYTE (TM), OPEN CV, and the like.

In accordance with at least one implementation, the placement (or non-placement) of the portable item 102 (for this non-limiting example, a television remote controller) on a given surfaces at the first location 130(1) and/or at a second location 130(2), and thus within portions of the living room 110, can be determined using one or more of the first and second living room cameras 102-LR(1)/(2) and image recognition technologies facilitated by the vision recognizer 204.

For at least one implementation, the vision recognizer 204 may perform portable item 102 detection and non-detection (e.g., by the absence of a given portable item at a given location 130 and at a given time) by iteratively using two or more, “n” models, “n” being an integer, for example, a first model of a given location (herein a “location model”), and a second model of a given portable item 102 or other object (herein, a “portable item model”). Using a location model and a portable item model, the vision recognizer 204 may be further configured to recognize the presence or absence of a given portable item 102 (or other object) at a given location 130, and at a given time, over a given period, or otherwise.

### Location Model

For at least one implementation, the vision recognizer 204 may generate a location model for a given surface, a given location, a given environ portion, and/or a given environ at a given level of specificity and/or granularity. A location model may be stored as a location data records 216 in the data store 210. For example, the location model may identify one or more surfaces, within a location 130, on a millimeter or centimeter basis, the location 130 may be modeled on a centimeter basis, the environ portion may be modeled on a meter basis, and the environ may be modeled on the basis of multiple meters or the like. The basis used may vary based upon characteristics of a given portable item 102 (or object) and/or the area being modeled. For example, detection of a remote-control device - a form of a portable item 102 - may occur when a location model is provided on a centimeter basis, whereas detection of a microSD card or the like may occur when a location model is provided on a millimeter basis.

The vision recognizer 204 may be configured to generate a location model using actual measurements, such as those taken by a laser measuring device, based upon image analysis, estimates, or otherwise. The location model may identify one or more reference surface(s) with respect to which the detection (or absence thereof) of a portable item 102 (or other object) is to occur. For example, the vision recognizer 204 may execute computer instructions, which based upon identifications of non-portable items, such as furniture, within a camera 106 FOV 124 and at a given location 130, can be used to establish a coordinate system for use in forming the location model and the detecting of portable items 102 at that location.

The vision recognizer 204 may be configured to use multiple coordinate systems to define a given surface and/or a given location 130, and at any given time. Such multiple coordinate systems may vary based upon positioning of portable items 102, non-portable objects that are movable, such as furniture, objects that are non-portable and non-movable, such as one or more walls or other fixed structures, and any other basis to be used for a given implementation of the present disclosure. For an implementation, one or more movable and/or non-movable objects may be used to define an environ or other environ portion.

For example, a given location 130 may be within the respective fields-of-view of multiple cameras 106. Such respective fields-of-view may include one or more surfaces within the given location 130. Images captured by a first camera may use a first coordinate system to determine orientation of surface at the given location 130, while images captured by a second camera may use a second and different coordinate system to determine orientation of the same or substantially the same surfaces at the given location 130. The vision recognizer 204 may be configured to translate between two or more coordinate systems to facilitate image detection using multiple cameras covering a given location 130. Such translations may be used generate one or more multi-dimensional location models, such as three-dimensional (“3D”) location models. As discussed above, the location models may be at given level of specificity including of specific surface (such as a top surface of an end table), of a location (such as the end table), of an environ portion (such as a room in which the end table is place), and/or an environ (such as a house, having walls), or otherwise to facilitate generation of a location model. Further, a location model, including 3D location models, may vary as changes occur at the relevant level of granularity. For example, a 3D location model may change when, for example, an end table includes a remote holder into which the remote (a portable item) may be located at varying times.

The vision recognizer 204 may be configured to iteratively or otherwise, rotate and manipulate the 3D location model in detecting the presence (or absence) of a given portable item 102 (or other object) at a given location and at a given time. Machine learning, artificial intelligence and other computer executable processes may be used to extrapolate portions of the 3D model which otherwise may not be otherwise available from actual measurements, images of the location, or otherwise.

### Portable Item Model

The vision recognizer 204 may be configured to generate a portable item model for a given portable item. The portable item model may be generated in any dimensions, including a planar dimension (as may occur from a still image), and/or multidimensionally, such as in 3D. The portable item model may vary based upon other dimensions, such as time, motion, or otherwise. For example, a portable item model of a static portable item may not vary over a given period (e.g., at night), whereas a portable item model of a deformable or otherwise configurable item (such as a pillow) may vary over time. Likewise, a portable item model for a portable item in motion or use may vary while the motion/use occurs and/or is expected and/or detected to occur. For example, a blanket in use may change form as a user thereof changes position in bed, while the blanket otherwise has a static form when not in use.

To generate the portable item model for a given portable item 102 (or other object), of which multiple models may exist and be used from time to time, the vision recognizer 204 may use image data obtained from one or more image data records. The image data records may include still images, motion video, computer generated virtualizations (e.g., based on shadows or other data indicative of a given location, characteristics, and/or orientation of an otherwise obscured or partially obscured portable item or other object), or other forms of image data. The image data records may be specific to a given portable item 102 (or object), to a class of portable items (or objects), or otherwise. The image data records may be populated based upon one or more images of the given portable item 102 (or object) obtained from any source, including by use of the one or more cameras 106, from online and/or Cloud databases, from manufacturer images, from social media images, machine generated images, images captured using a person’s smartphone, camera or the like, or from any singular source or combination of sources. The image data records may include images of the given portable item 102 (or other object) under various conditions, such as static, in use (e.g., as deformed or modified), in motion, in daylight, in nightlight, in visible light, in infrared wavelengths, and/or otherwise.

The vision recognizer 204 may execute computer instructions which, based on one or more images in the image library records 212, virtually rotates, orients, extrapolates or otherwise facilitates generation of a portable item model for the given portable item 102 (or other object). A portable item model may vary from one version to another based on one or more use conditions and/or locations and/or based on any other given level of specificity. For example, an image model for a given portable item 102 (or other object) in daylight may vary from an image model for that given portable item 102 (or object) in the dark.

The vision recognizer 204 may be configured to generate a portable item model based on image data captured from the perspective of one or more fields of view (as may be supported for a given camera 106 or multiple cameras, orientations of the portable item 102 (or other object) with respect to one or more given surfaces within a given location 130, and otherwise. For example, a portable item 102 may have the form of a remote-control device (a remote) that is placed on a surface, from time to time, on its back, front, a side, or otherwise and at any given orientation, including random orientations. The orientation of the remote to the surface may result in the generation of image models that vary over time relative to a given fixed or determinable orientation of the surface, such as an end portion of a table forming a corner with a side portion of the table and thus an X-Y plane – such surface being captured in a location model, as provided in a location data records 216 and as further described herein. Likewise, the position of the remote on the surface may vary by height, such as when positioned on a book or other item on the surface, and thus the position of the remote may change along a Z axis of an X-Y-Z coordinate system and the representation of the portable item, in a given portable item model, having a different scale or perspective, as viewed by a camera, may be used in conjunction with a given location model having a similar FOV, orientation, perspective, or otherwise.

It is to be appreciated that a change of height, a rotation, an inclination, or other positioning (herein “positioning” and/or “position”) of a portable item 102 (or other object) from time to time, may result in a relation of the portable item 102 (or other object) within a FOV of one or more cameras 106 changing from one image to another and thus changing with respect to a given location model, such as one then being used by the vision recognizer 204. Such changes may influence the relation of the portable item 102 (or other object) to one or more coordinate systems used with respect to a given location model and/or a relation of a number of pixels or the like used to capture an image of the portable item 102 (or other object) at a first position versus those used at a second position. For example, a locating of a portable item 102 (or other object) closer to a camera 106 with a fixed FOV will commonly result in the portable item 102 (or other object) being captured in more pixels of the camera 106 than when the portable item 102 (or other object) is located at a further distance from the camera 106.

To address these and other concerns, the vision recognizer 204 may execute computer instructions which first facilitate detection of the portable item 102 (or other object) based upon the scaling up/down (as the case may be) of one or more scalable portable item models and/or the adjustment of one or more location models. The scalable portable item models may be obtained, when already stored, and/or generated from one or more image library records 212. The location models may be obtained, when already stored, and/or generated from a location data records 216. By adjusting one or more of a scalable portable item model and/or a scalable location model, enlargements and/or reductions of an image of a portable item 102 (or other object) within a given FOV, as captured by a given camera image, may occur even when the scaling of the portable item model and the location model may vary.

To facilitate the generation of scalable portable item models, for at least one implementation, the system 100 uses multiple image models, which may be generated based on the images provided in one or more image data records stored in the image library records 212. The images may be captured at multiple focal points, fields of view and/or in view of one or more, fixed or variable, camera settings. The use of image models facilitate the virtual rotation, expansion, contraction and other manipulations of a portable item model of a given portable item 102 (or other object) such that a portable item 102 (or other object), in one or more randomly varying positions, with respect to a given surface, location 130, or otherwise may be detected and identified (when present at such location) by the vision recognizer 204. To facilitate the image modeling, positioning virtualization, scaling and portable image detection, the vision recognizer 204 may use any known neural networks, machine learning processes and the like. Iterative processes may be used whereby scaled portable item models and location models are varied to determine whether the portable item is at a given location and at a given time or over a given period. The iterative processes may use any given number of iterations in determining whether, based on one or more scaled portable item models and one or more scaled location models, a given portable item 102 (or other object) is present at a given location 130, at a given time.

Using one or more of the above processes, the location model(s), and the portable item model(s) the vision recognizer 204 may be configured to detect a change, presence, or absence of a given portable item 102(or other object) with respect to a given location 130.

For example, the remote control may be detected as being present within the first location 130(1) at a first time while at a second time, the remote control may be detected as being present within the second location 130(2) – it being appreciated that different location models being used and that the orientation of the remote control may vary to facilitate such detections.

The vision recognizer 204 may be configured to identify, based upon a given number of iterations of movements of a given portable item 102 (or other object) by a user or otherwise, to identify one or more trends, common practices, or the like (herein, a “user habit”) with respect to the given portable item 102 (or other object or a collection thereof). One or more user habits may be stored as one or more user data records 214 in the data store 210. User data records 214 may be common or unique to one or more portable items 102 (or other object), users, locations 130, times of day, and otherwise. For example, a user may commonly move a remote control, within a living room 110, from a table to a couch while watching a television and may commonly return the remote to the table when such television watching has ended. Such movements, as tracked by a user tracker 206, may constitute a remote-control user habit. Similarly, a user may commonly place their glasses on a nightstand when preparing for sleep, the placement of such glasses being another example of a user habit. User habits may be used to populate user data records 214, as stored by the data store 210.

The identification of a user habit, by the vision recognizer 204 may be accomplished using user data records 214, location data records 216, user location data records 220, PIL data records 218, and/or combinations of the foregoing. For at least one implementation, a hub 104 may be configured to track user locations, in conjunction with the ULTS 150, and populate user location data records 220 records in the data store 210.

Based on one or more user data records 214, such records identifying one or more user habits, the vision recognizer 204 may be configured to perform searches for a given portable item 102 (or other object), at a given location 130, and at a given time. For example, the vision recognizer 204 may seek to determine whether the user’s glasses are on the nightstand when the user commonly goes to bed, as may be represented by a user habit. The determining of whether such glasses are so present may occur, for at least one implementation, by the vision recognizer 204 obtaining a portable item model from the image library records 212 (the portable item model having already been generated and stored in the data store 210), obtaining, from the location data records 216, a location model that includes the relevant surface (in this example, the top portion of the nightstand), capturing one or more current images from a camera 106 positioned to have a FOV that includes the relevant surface, manipulating the current image(s) to orient the image with the location model (so as to provide a reference basis) and second orienting elements of the current image(s) to determine whether the current images include a shape, in two or more dimensions, that correspond to the previously retrieved portable item model. For at least one implementation, the process may further include scaling up/down, rotating, orienting, or otherwise manipulating one or more of the portable item model, the location model and/or the images such that the vision recognizer 204 can recognize the portable item (the glasses).

For at least one implementation and based upon one or more identified user habits, the vision recognizer 204 may be configured to determine when and/or whether to perform vision recognition processes for one or more portable items 102 (or other objects). For example, the vision recognizer 204 may analyze one or more images captured by one or more cameras 106 at a given time, to determine whether the given portable item 102 (or other object) (in this example, the remote control) is present or not present at the given location 130 (such as being present on the table versus on the couch), and at a given time.

Using user data records 214, including user habits, the vision recognizer 204 may be configured to determine whether a present user’s actions are conforming or non-conforming with a previously determined user habit. For example, a determination may be made as to whether the user place the glasses on the nightstand, or were the glasses left elsewhere, such as in the living room? When the user’s actions are conforming with a given user habit, the vision recognizer 204 may be configured to not take any further actions. When the user’s actions are non-conforming, the vision recognizer 204 may be configured to alert the hub 104 to take further actions, such as sending alerts (via any medium) to a user or others of the non-conforming positioning of the given portable item, performing a search and detection for the portable item; such search and detection may be initiated, for example, based upon a last known location for a given portable item 102, as provided in one or more portable item location data records 218 stored in the data store. The portable item location data records 218 provide location information for an object and may be generated by a portable item tracker 208, as discussed below.

It is to be appreciated that a user habit may vary over time, day of week, or otherwise. Accordingly, multiple user habits may be utilized by the vision recognizer 204 to determine whether a positioning of a given portable item, at a given time, and at a given location, is conforming or non-conforming with a given user habit identified out of a population of one or more user habits.

It is to be appreciated that a given portable item 102 (or other object), being portable, may change locations over time and such change of detection may not be trackable by the portable item tracker 208 for any reason, such as insufficient granularity of position data, signal interferences inhibiting tracking of a portable item 102 (or other object), battery and power concerns for a PILT 142, and otherwise. For example, a user may pick-up and relocate the remote from the first location 130(1) to the second location 130(2) in the living room 110 and portable item tracker 208 may be configured to track portable items on a room-by-room basis and not on a location by location (within a room) or surface by surface (within a location) basis.

Provided the remote is within the FOV of one of the living room cameras 102-LR(1)/(2), the movement of the remote, for example, from the first location 130(1) to the second location 130(2) may be visually tracked by the vision recognizer 204, with such tracking data being shared with the portable item tracker 208 in order to populate PIL data records 218. Further, the portable item tracker 208 may be configured to maintain and update, as needed, PIL data records 218 in the data store 210 based on detections of the portable item by the vision recognizer 204 and as communicated by the vision recognizer 204 to the portable item tracker 208.

The PIL data records 218 may include a current location, one or more past locations, one or more designations of given locations for a portable item 102 (or other object) at a given time, and the like. For example, the positioning of the remote may be determined by the vision system 1104 to be conforming when the current position of the remote/portable item is known, even when such positioning may be contrary to a given user habit.

The position records and/or user habit record may assist the vision recognizer 204 in determining where and when to search for a portable item 102 (or other object) that is not at a given location 130, and/or at a given time. When the portable item 102 (or other object) is not detected as being present at the given location, or other locations as indicated by PIL data records 218, the vision recognizer 204 may be configured to utilize one or more user location data records 220, as generated by the user tracker 206 and stored in the data store 210.

The user location data records 220 identify current and past locations of a given user within the environ. As discussed herein, the environ may be any specified level of abstraction of a physical space, such as by country, state, street, address, room, portion of a room or otherwise. The level of physical space abstraction utilized for the ULTS 150 may vary by location, and other factors. For at least one implementation, the vision recognizer 204 may use the user location data records 220, indicating a course taken by the user between a previously known location for a given portable item 102 (or other object), as maintained by the portable item tracker 208 and identified in a portable item location data records 218, to a current location, as determined by the user tracker 206, and as maintained in a user location data records 220, to designate locations along the route to search for the portable item 102 (or other object). For example, the user’s route may be from the first location 130(1) in the living room 110 to the bedroom 118 with a stop-over in the kitchen 114. Given such a route, as provided by the user tracker 206, the vision recognizer 204 may conduct searches for the portable item 102 (e.g., the glasses), using one or more of the first living room camera 106-LR(1), the second living room camera 106-LR(2), the entry/hall camera 106-H, the kitchen camera 106-K and the bedroom camera 106-BR while not conducting searches for the portable item using other cameras not along the route.

For at least one implementation of the present disclosure, the vision recognizer 204 may be configured to generate one or more messages, or the like to alert the user (and/or others) that the portable item 102 (or other object) is missing, located at a location contrary to a user habit, or otherwise. Such messages may inform a user, and/or others, that the portable item 102 (or other object) is not present at the designated location, and at the designated time, may identify the designated location, may identify the current location of the portable item 102 (or other object of interest) (if known) and may instruct a given user(s) to reposition the portable item 102 (or other object) to the designated location, or the like. For example, a portable item 102 might be a cane that, per a given user habit, is commonly located bedside of a given cane user, at a given time, such as when they awaken. If the cane is not so positioned, an alert message may be provided to a caregiver or other person to re-locate the cane. In response to such message, appropriate actions may be taken by the one or more users receiving such message. Such actions may include: updating the PIL data records 218 with the known current location of the portable item 102; physically repositioning the portable item 102 (or other object) so it is at the location indicated by a user habit, a current need, or otherwise; initiating a search for the portable item 102 (or other object); alerting others that the portable item 102 (or other object) is missing (e.g., and may need replacement); or taking any other action.

### User Tracker 206

The processor 202 may be configured to instantiate, as an engine, logic, module, or otherwise, a user tracker 206 which performs operations including receiving UTD data from the ULTS 150 and maintaining the user location data records 220 in the data store 210. Other operations performed by the user tracker 206 are variously described herein.

### Portable Item Location (PIL) Tracker 208

The processor 202 may be configured to instantiate, as an engine, logic, module, or otherwise, a PIL tracker 208 which performs operations including receiving PIL data from the PILTS 140 and maintaining the PIL data records 218 in the data store 210. Other operations performed by the PIL tracker 208 are variously described herein.

### Interfaces 222

The hub 104 may include one or more interfaces 222 which facilitate interactions by the hub 104 with an operator thereof, as provided by an operator interface 224; with one or more cameras 106, as provided by a camera interface 226; with the ULTS 150, as provided by a user tracker interface 228; and with a PILTS 140, as provided by a PILTS interface 230.

More specifically and for at least one implementation, the interfaces 222 include hardware and software components which facilitate communications between two or more elements of the system 100. For example, and not by limitation, the interfaces 222 includes currently known and/or later arising antennas, ports, connectors, transceivers, data processors, signal processors and the like which facilitate connection of the hub 104 to a network (as described above). Such elements are well known in the art and are individually and collectively referred to herein as one or more of the interfaces 222.

Non-limiting examples of technologies that may be utilized with the interfaces 222 and in accordance with one or more implementations of the present disclosure including Bluetooth, ZigBee, Near Field Communications, Narrowband IOT, WIFI, 3G, 4G, 5G, cellular, and other currently arising and/or future arising wireless communications technologies. The interfaces 222 may be configured to include one or more data ports (not shown) for establishing connections between a hub 104 and another device, such as a laptop computer. Such data ports may support any known or later arising technologies, such as USB 2.0, USB 3.0, ETHERNET, FIREWIRE, HDMI, and others. The interfaces 222 may be configured to support the transfer of data formatted using any protocol and at any data rates/speeds. The interfaces 222 may be connected to one or more antennas (not shown) to facilitate wireless data transfers. Such antenna may support short-range technologies, such as 802.11a/c/g/n and others, and/or long-range technologies, such as 4G, 5G, and others. The interfaces 222 may be configured to communicate signals using terrestrial systems, space-based systems, and combinations thereof systems. For example, a hub 104 may be configured to receive GPS signals from a satellite directly, by use of an intermediary device (not shown), or otherwise.

### Operator Interface 224

The operator interface 224 includes commonly known and/or later arising components which facilitate hub 104 to operator interchange of data and information, as used herein, “information” refers to data that is provided/output in a humanly perceptible form to a person. The person may be an operator, a user of a portable item 102, a bystander, or otherwise. Non-limiting examples of the operator interface 224 components include those facilitating the providing of data, in an information form, to an operator in one or more of an audible, visual, tactile, or other format.

For example, an operator interface 224 may include an audio input/output (I/O) interface, support a receiving and/or presenting of audible content to a person via a hub 104 and/or other device, such as smartphone associated with a given person, or otherwise. Such audible content(which is also referred to herein as being “audible signals”) may include spoken text, sounds, or any other audible information. Such audible signals may include one or more of humanly perceptible audio signals, where humanly perceptible audio signals typically arise between 20 Hz and 20 KHz. The range of humanly perceptible audio signals may be configurable to support an audible range of a given individual person.

An audio I/O interface includes hardware and computer instructions (herein, “audio technologies”) which supports the input by and output to, of audible signals to a person. Such audio technologies may include noise cancelling, noise reduction, technologies for converting human speech to text, text to speech, translation from a first language to one or more second languages, playback rate adjustment, playback frequency adjustment, volume adjustments and otherwise.

An audio I/O interface may use one or more microphones and speakers to capture and present audible signals respectively from and to a person. Such one or more microphones and speakers may be provided by a given hub 104 itself or by a device communicatively coupled to an audible device component. For example, earbuds may be communicatively coupled to a smartphone, with the earbuds functioning as an audio I/O interface and capturing and presenting audio signals as sound waves to and from a given person. For at least one implementation, the smartphone may function as a hub 104.

An audio I/O interface may be configured to automatically recognize and capture comments spoken by a person and intended as audible signals for sharing with others, with the hub or otherwise. For example, a user of a portable item may desire to find the portable item and may issue a command or query to the hub 104 to identify the last known location of the portable item. In response to such a query, the hub 104 may identify the last known location using an audible, visual or other signal. In an implementation, the hub 104 may identify the portable item 102 by activating one or more elements thereof, such as a speaker, lights, or otherwise.

An operator interface 224 may include a visual I/O interface configured to support the receiving and presenting of visual content (which is also referred to herein as being “visible signals”) with a person. Such visible signals may be in any form, such as still images, motion images, augmented reality images, virtual reality images, and otherwise.

A visual I/O interface includes hardware and computer instructions (herein, “visible technologies”) which supports the input by and output of visible signals to a person. Such visible technologies may include technologies for converting images (in any spectrum range) into humanly perceptible images, converting content of visible images into a given person’s perceptible content, such as by character recognition, translation, playback rate adjustment, playback frequency adjustment, and otherwise.

A visual I/O interface may be configured to use one or more display devices, such as the internal display (not shown) and/or external display (not shown), that are configured to present visible signals to the person. A visual I/O interface may be configured to use one or more image capture devices to capture content, including instructions provided by a person, such as sign language, arm motions, or the like. Non-limiting examples of image capture devices include the cameras 106 of the system 100 and may include other cameras and the like provided by other devices, such as smartphones, laptop computers and the like. It is to be appreciated that any existing or future arising visual I/O interfaces, devices, systems and/or components may be utilized by and/or in conjunction with a hub 104 to facilitate the capture, communication and/or presentation of visual content(i.e., visible signals) to a person.

### Camera Interface 226

The camera interface 226 includes commonly known and/or later arising components which facilitate hub 104 with camera 106 communications of data and control signals. The data communicated by a camera 106 to the hub 104 may include images, status information, camera settings, or the like. As per above, the images may take any form.

The camera interface 226 may include any known or later arising camera interface and/or image processing technologies known in the art and/or later arising. For a non-limiting example, when a CANON camera is utilized, the camera interface may include the CANON EOS UTILITY application (as available for download online at https://www.usa.canon.com/internet/portal/us/home/support/self-help-center/eos-utility). Other non-limiting examples of camera interface and/or image processing technologies, including encryption/decryption, compression/decompression, noise limiting, filtering, and other signal processing technologies. The camera interface 226 may also include image processing technologies which convert images between different formats, such as infra-red captured images converted to visible light image representations, motion images converted to still images and vice versa, and the like. Any known or later arising image processing technologies may be provided by the camera interface 226 with the vision recognizer 204.

The camera interface 226 may be configured to communicate control signals from the hub 104 to one or more cameras 106. Non-limiting examples of such control signals include power-on/power-off, capture (e.g., take a picture), begin motion video capture, end motion video capture, hyper lapse signals (e.g., start time, frequency between captures, and end time), pan, zoom in or out, activating a flash, instructing other lighting controls (e.g., of lights within an environ and/or illuminating a location or surface), changing FOV utilized, image data format, and the like.

When a PILN is provided in conjunction with a camera 106, PILT data may be communicated from the camera to the hub 104 and the camera interface 226 may be provided in conjunction with and/or combined with the PILTS interface 230 to receive and process the PILT data. Further, when UTD data is generated using a PILN, the camera interface 226 may be provided in conjunction with and/or combined with the PILTS interface 230 and/or the ULTS interface 228.

### ULTS Interface 228

The user location tracking system (ULTS) interface 228 includes commonly known and/or later arising components which facilitate hub 104 with UTD communications of data and control signals. The data communicated may include position information, user biometric (as may be captured, for example, by a fitness tracker or smart watch), and any other known or later arising data that identifies a user location (at a given level of positional determination) and, for at least one implementation, may identify a state or status of the user (e.g., sleeping, moving, stationary, or otherwise).

### PILTS Interface 230

The portable item location tracking system (PILTS) interface 230 includes commonly known and/or later arising components which facilitate hub 104 with PILN communications of data and control signals. The data communicated may include position information, and any other known or later arising data that identifies a portable item location (at a given level of positional determination) as represented by a location of a PILT.

### Data Store 210

Any known or later arising storage technologies may be utilized for the data store 2104. Non-limiting examples of devices that may be configured for use as data store 210 include electrical storages, such as EEPROMs, random access memory (RAM), Flash drives, and solid-state drives, optical drives such as DVDs and CDs, magnetic storages, such as hard drive discs, magnetic drives, magnetic tapes, memory cards, such as Compact Flash (CF), Secure Digital (SD) cards, Universal Serial Bus (USB) cards, and others.

The data store 210 may be a storage, multiple storages, or otherwise. The data store 210 may be configured to store image data records in image library records 212, user data records 214, location data records 216, PIL data records 218, user location data records 220, and other data. The data store 210 may be provided locally with the hub 104 or remotely, such as by a data storage service provided on the Cloud, and/or otherwise. Storage of data may be managed by a storage controller (not shown) or similar component. It is to be appreciated such storage controller manages the storing of data and may be instantiated in one or more of the data store 210, the processor 202, on the Cloud, or otherwise. Any known or later arising storage technologies may be utilized in conjunction with an implementation of the present disclosure to facilitate the data store 210.

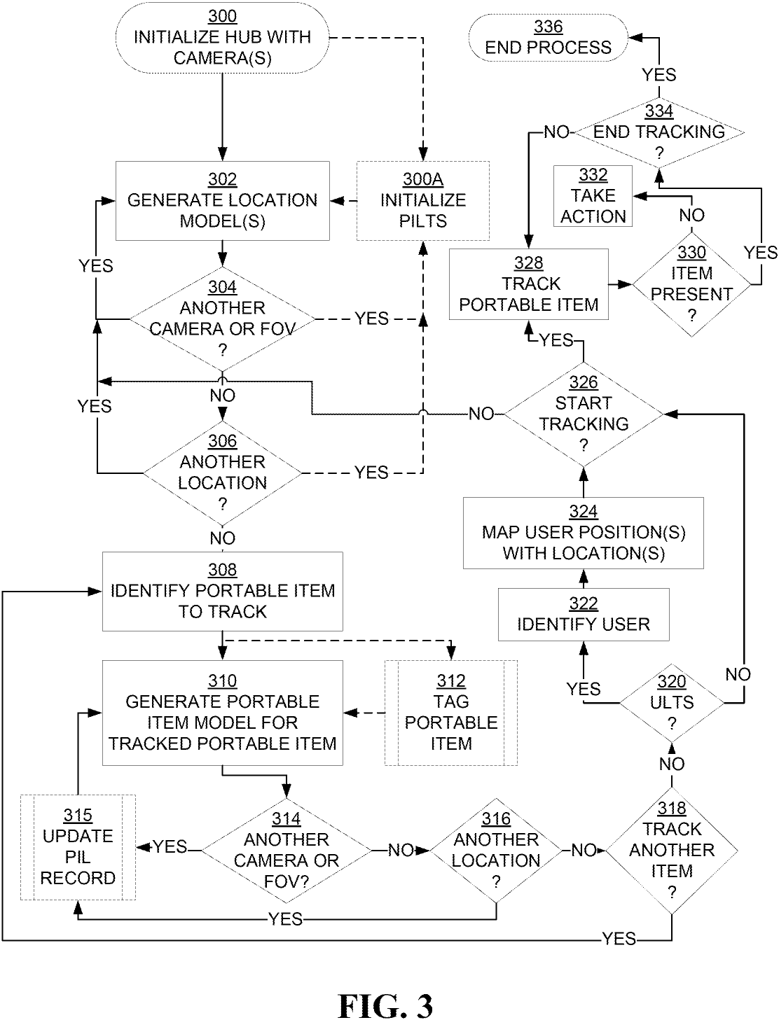

In FIG. 3, one implementation is shown of a process for tracking portable items 102 (and/or other objects).

In Operation 300, the process may begin with initializing a hub 104 with one or more cameras 106. Initialization may involve loading data into the camera interface 226 that identifies the image types supported by the camera, camera settings, and the like. The initialization may also include determining fields of view supported by a given camera, locations and objects within such fields-of-view and the like. The initialization process may also include the operations of initializing a PILTS with the hub, as per Operation 300A. During PILTS initialization, data may be exchanged between a given PILN 144 and the hub 104 which identifies the location of the PILN 144 in the environ, communications frequencies utilized, and the like.

In Operation 302, the process may include generating one or more location models for a given camera 106. As discussed above, the location models may be used to provide a representation of a location 130. Any number of location models may be generated. The location models are stored as location data records 216 in the data store 210.

In Operation 304, the process may include determining whether another camera 106 or another FOV, or another camera setting, or the like for a given camera 106 is available for use in generating a location model for a given location 130, object, or other environ portion. If so, additional location models may be generated and/or existing location models may be updated based upon image data captured by the camera(s). It is to be appreciated that with additional cameras and/or additional FOVs, multi-dimensional models, such as 3D models, of a location or object may be generated and stored as one or more location data records 216 in the data store 210.

In Operation 306, the process may include determining whether a location model is to be generated for another location or object within an environ, an environ portion, or otherwise. It is to be appreciated that multiple location models may be generated, as per Operations 302-304, and used to track portable items 102 (or other objects) throughout a portion of a given environ 108.

In Operation 308, the process may include identifying one or more portable item 102 (or other objects) to be tracked. Identification of the portable items 102 (or other objects) may include generating PIL data records 218 in the data store 210.

In Operation 310, generating one or more portable item models. As discussed above, portable item models may be generated based on images of a portable item 102 (or other object), where the images may be provided by any source. For at least one implementation, the images used to generate a portable item model may be generated by a camera 106 in the system 100. Multiple images may be used in generating a portable item model and the model may be generated in any number of dimensions including 3D.

In Operation 312, the identifying of one or more portable items 102 (or other objects) may include the process of tagging the portable item 102 (or other object) with a PILT 142 The tagging may include updating the PIL records 218 to provide an association of a given portable item 102 (or other object) with a given PILT 142, as stored in the PIL data records 218 or other records in the data store 210.

In Operation 314, the process may include determining whether a portable item model is to be generated for a given portable item 102 (or other object) using another camera 106, another FOV, another camera setting, or the like.

In Operation 315, which may occur when a PILTS 140 is used, the portable item model generation of Operations 310-316 may include updating the PIL data records 218 to identify a location of the given portable item 102 (or other object) that corresponds with the data, including image data, used to generate a given portable item model in view of a given camera 106, FOV, camera setting, location, or the like.

In Operation 316, the process may include determining whether a portable item model is to be generated for a given portable item 102 (or other object) at another location. For at least one implementation, a portable item model may be generated for a location model generated per Operations 302-306. It is to be appreciated that by generating portable item models at multiple locations, tracking of a portable item 102 (or other object) throughout an environ 108 may facilitate more precise inspections of images against location models and portable item models corresponding thereto. Further rotations, re-orientations and the like of images of a given location 103 may be manipulated in view of portable item models that correspond to a given location model.

In Operation 318, the process may include determining whether another portable item 102 (or other object) is to be tracked. If yes, Operations 308-316 are repeated until the portable items 102 (or other object) to be tracked have been modeled and tagged (when a PILTS is being used).

In Operation 320, the process may include determining whether a user location tracking system (ULTS) is to be utilized. If so, the process continues with Operation 322.

In Operation 322, the process may include identifying a user and associating the user with the system 100. User identification may include any operations commonly used to associate a UTD 152 with another electronic device, such as the hub 104. The association may include the interchange of data utilized to pair the UTD 152 with the hub 104, as facilitated by the user tracker interface 228, and otherwise.

In Operation 324, the process may include mapping one or more user positions, as determined, for example, using the ULTS 150 and a UTD 152, with one or more locations 130, as provided, for example, in one more location model records previously generated per Operations 302-306. Such mapping may occur with respect to one or more of the locations 130 identified in the location models.

In Operation 326, the process may include awaiting an instruction, from an operator or otherwise, to begin tracking of one or more portable items 102 (or other objects) within an environ 108. When tracking is not started, the process may continue at any of the described operations, with FIG. 3 showing, for purposes of illustration, the process continuing at Operation 302.

In Operation 328, the process includes tracking of a portable item 102 (or other object) within a given environ 108. The tracking of a portable item 102 (or other object) may depend upon the data available, at a given time, to the hub 104. Such data may include image data records stored in the image library records 212 captured by one or more cameras 106, location data records 216, and other records.

In Operation 330, the process may include detecting a presence or an absence, as the case may be, of a portable item 102 (or other object) at a given location 130. Operation 330 may include us of the mentioned records as well as user data records 214 which specify when a given portable item 102 (or other object) is to be detectable at a given location 130. Operation 330 may include iterative orientations of one or more location models, portable item models, current image data, and the like in determining whether a portable item 102 (or other object) is at the given location 130, at a given time. Operation 330 may also include checking with the PILTS 140 to obtain current location data for a PILT 142 associated with the given portable item 102 (or other object) to determine is such PILT data corresponds with the given location 130.

In Operation 332, the process may include taking corrective action when the portable item 102(or other object) is not present at a given location 130. As discussed above, such corrective action may include generating alert messages or other actions.

In Operation 334, the process may include determining whether tracking of a portable item 102 (or other object) is to end. If yes, then the process ends, as per Operation 336, with respect to the tracking of one or more portable items 102 (or other objects). When tracking has ended with a portable item 102 (and any other objects) associated with a given environ 108, then the process terminates. Otherwise, the process may continue with additional tracking of one or more portable items 102 (or other objects), as per Operation 328.

The various operations shown in FIG. 3 are described herein with respect to at least one implementation of the present disclosure where a portable item 102 (or other object) is to be tracked within a given environ 108. It is to be appreciated that when multiple users are present in a given environ 108 and/or multiple portable items 102 (or other objects) are to be tracked, the hub 104 may be configured to dynamically track multiple portable items 102 (or other objects) and multiple users. The described operations may arise in the sequence described, or otherwise and the various implementations of the present disclosure are not intended to be limited to any given set or sequence of operations. Variations in the operations used and sequencing thereof may arise and are intended to be within the scope of the present disclosure.

Although various implementations have been described with a certain degree of particularity, or with reference to one or more individual implementations, those skilled in the art could make alterations to the disclosed implementations without departing from the spirit or scope of the claims. The use of the terms “approximately” or “substantially” means that a value of an element has a parameter that is expected to be close to a stated value or position. As is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom”, “left” and “right”, “up” or “down”, “first”, “second”, “next”, “last”, “before”, “after”, and other similar terms are used for description and ease of reference purposes and are not intended to be limiting to any orientation or configuration of any elements or sequences of operations for the various implementations of the present disclosure. Further, the terms “coupled”, “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any combinations of elements and operations of an implementation of the present disclosure. Other implementations are therefore contemplated. It is intended that the matter contained in the above description and shown in the accompanying drawings shall be interpreted as illustrative implementations and not limiting. Changes in detail or structure may be made without departing from the basic elements recited in the following claims.

Further, a reference to a computer executable instruction includes the use of computer executable instructions that are configured to perform a predefined set of basic operations in response to receiving a corresponding basic instruction selected from a predefined native instruction set of codes. It is to be appreciated that such basic operations and basic instructions may be stored in a data storage device permanently, may be updateable, and are non-transient as of a given time of use thereof. The storage device may be any device configured to store the instructions and is communicatively coupled to a processor configured to execute such instructions. The storage device and/or processors utilized operate independently, dependently, in a non-distributed or distributed processing manner, in serial, parallel or otherwise and may be located remotely or locally with respect to a given device or collection of devices configured to use such instructions to perform one or more operations.

What is claimed is:

1. A system, tracking an object within an environ, comprising:
a hub comprising:
a processor executing non-transient computer instructions which instantiate a vision recognizer;
a data store, coupled to the processor, non-transiently storing: a location data record including a first location model for a first location; and
a first camera, coupled to the hub;
wherein the first camera is positioned to capture, within a first field of view (FOV), a first image and provide the first image to the hub;
wherein the first FOV covers a first captured location;
wherein the first image includes a first depiction of the first captured location; and
wherein the vision recognizer determines whether an object is present at the first location by determining whether the first depiction of the first captured location in the first image corresponds to the first location model for the first location.

2. The system of claim 1,
wherein the first image further depicts an element, if any, present within the first FOV;
wherein the data store further stores an image library record that includes a first object model for the object; and
wherein the vision recognizer further determines whether the object is present at the first location by determining whether the element depicted in the first image corresponds to the object as modeled by the first object model.

3. The system of claim 2,
wherein the object is a portable item.

4. The system of claim 2,
wherein the vision recognizer detects whether the object is present at the first location by further executing instructions comprising:
first orienting the first location model to a first reference coordinate system; and
second orienting the first object model to the first reference coordinate system.

5. The system of claim 4,
wherein the vision recognizer detects whether the object is present at the first location by further executing instructions for:
third orienting the first image to the first reference coordinate system; and
wherein the determining of whether an object is present at the first location uses the first object model as second oriented to the first reference coordinate system.

6. The system of claim 5,
wherein the vision recognizer detects whether the object is present at the first location by further executing instructions comprising:
obtaining a second object model;
third orienting the second object model to the first reference coordinate system; and
wherein the determining of whether the element depicted in the first image corresponds to the object as modeled by the first object model further comprises:
searching, utilizing the second object model, as third oriented, for the object in the first image.

7. The system of claim 6,
wherein the vision recognizer detects whether the object is present at the first location by further executing instructions comprising:
iteratively:
obtaining a third object model through an nth object model of the object; wherein “n” is an integer;
orienting the third object model through the nth object model to the first reference coordinate system; and
searching, until detected, for the object in the first image using the third object model through nth object model.

8. The system of claim 7,
wherein, upon detection of the object in the first image for an iterative given utilization of one of the third object model through the nth object model, the instructions further comprise:
identifying the object as being present at the location; and wherein, upon non-detection of the object in the first image after the nth object model, the instructions further comprise:
determining the object is not present at the first location.

9. The system of claim 7,
wherein the vision recognizer detects whether the object is present at the first location by further executing instructions comprising:
obtaining a second location model;
orienting the second location model to the first reference coordinate system; and
iteratively:
obtaining the second object model through the nth object model;
orienting the second object model through nth object model to the first reference coordinate system; and
searching for the object in the first image.

10. The system of claim 9,
wherein at least one of the first location model and the second location model comprises a three-dimensional (3D) location model;
wherein at least one of the first object model through the nth object model comprises a 3D object model; and
wherein the vision recognizer detects whether the object is present at the first location by further executing instructions comprising:
iteratively rotating, around an axis of the first reference coordinate system:
the 3D location model;
the 3D object model; and
the image; and
searching for the object in the first image with an iterative rotation of the first reference coordinate system.

11. The system of claim 2, further comprising:
a second camera, coupled to the hub;
wherein the second camera is positioned to capture, within a second FOV, a second image of the first location and provide the second image to the hub; and
wherein the vision recognizer determines, based upon the second image, the image library record and the location data record whether the object is present at the first location at the second image capture time.

12. The system of claim 11,
wherein the first image capture time and the second image capture time occur simultaneously.

13. The system of claim 2, further comprising:
a portable item location tracking system (PILTS), coupled to the hub comprising:
a portable item location tag (PILT); and
a portable item location node (PILN);
wherein the PILT is attached to the object;
wherein the PILN is attached to the first camera; and
wherein the PILT is coupled to the PILN when the PILT is located within a wireless communications signal range of a lesser of the PILT and the PILN;
wherein the PILTS provides, to the hub, object location information for the object when the PILT is coupled to the PILN; and
wherein the object location information is stored in a portable item location (PIL) data record.

14. The system of claim 13,
wherein the vision recognizer detects whether the object is present at the first location by further executing instructions comprising:
obtaining the object location information from the PIL data record; and
determining, based on the object location information, whether to take any further actions to determine whether the object is present at the first location.

15. The system of claim 14, further comprising:
a user location tracking system (ULTS), coupled to the hub, comprising:
a user tracker device (UTD) that captures user tracking data; wherein the data store further comprises:
a user location data record storing the user tracking data; and wherein, during a normal day, the UTD is concomitant with a user of the object.

16. The system of claim 15,
wherein, when the object is not present at the first location, the instructions further comprise:
identifying where the user has traveled throughout the environ, as indicated by user tracking data;
identifying, based on the user tracking data, a second location within a second FOV of a second camera;
wherein the second camera provides second images of the second location to the hub for storage in an image library record maintained by the data store;
retrieving, from the data store, at least one of second image corresponding to when the user was at the second location, as identified by the user tracking data; and
determining whether the object is present at the second location.

17. The system of claim 16,
wherein the location data record includes a second location model for the second location; and
wherein the determining of whether the object is present at the second location utilizes the second location model in place of the first location model.

18. A device comprising:
a processor executing non-transient computer instructions which instantiate a vision recognizer; and
a data store, coupled to the processor, non-transiently storing:
a location data record including a first location model for a first location;
an image library record including a first portable item model for a portable item;
a portable item location (PIL) data record storing location data for a portable item; and
a user location data record storing user tracking data;
wherein the vision recognizer determines whether the portable item is present at a first location by determining whether a first depiction of a first captured location in a first image provided to a hub by a first camera corresponds to a first location model for the first location obtained from the location data record; and
wherein the vision recognizer further determines whether the portable item is present at the first location by determining whether an element depicted in the first image corresponds to the portable item as modeled by a first portable item model obtained from the image library record.

19. The device of claim 18,
wherein the data store further non-transiently stores:
a portable item location (PIL) data record storing PIL data identifying at least
one of a current or past known location for the portable item; and a user location data record storing user tracking data;
wherein the processor further executes non-transient computer instructions which instantiate:
a user tracker; and
a PIL tracker;
wherein the vision recognizer chooses, based on the user tracking data and the PIL data, a second camera image to utilize, at a given time, to determine whether the portable item is present at a given location; and
wherein the second camera image was captured by a second camera that corresponds to at least one of the current or past known location for the portable item; and
wherein the vision recognizer further selects, based on the user tracking data, a third camera image to use when the portable item is not detected using the first image or the second image; and
wherein the third camera image corresponds to a current or past known location of the user, as identified in the user tracking data.

20. A computer readable medium non-transiently storing computer instructions which, when executed by a processor, instruct a hub device in a system tracking portable items to perform operations comprising:
first determining whether a portable item is present at a first location by determining whether a first depiction of a first captured location in a first image captured by a first camera in a system tracking portable items corresponds to a first location model, for the first location, obtained from a location data record stored by a hub device; and
second determining whether the portable item is present at the first location by determining whether an element depicted in the first image corresponds to the portable item as modeled by a first object model obtained from an image library record stored by the hub device.
